(19) United States
(12) Patent Application Publication
(10) Pub. No.: US 2019/0319230 A1
(43) Pub. Date: Oct. 17, 2019

(54) POWER SOURCE ASSEMBLY FOR GIMBAL, BATTERY ASSEMBLY, AND GIMBAL

(71) Applicant: SZ DJI OSMO TECHNOLOGY CO., LTD., Shenzhen (CN)

(72) Inventors: Shimeng BEI, Shenzhen (CN); Feng ZHU, Shenzhen (CN); Yanchong ZHAO, Shenzhen (CN)

(21) Appl. No.: 16/451,894

(22) Filed: Jun. 25, 2019

Related U.S. Application Data
(63) Continuation of application No. PCT/CN2016/112558, filed on Dec. 28, 2016.

(51) Int. Cl. H01M 2/10; F16M 11/12; F16M 11/20

(52) U.S. Cl. CPC H01M 2/1027; H01M 2/1011; F16M 11/205; F16M 11/123

(57) ABSTRACT

A power source assembly for a gimbal includes a main body including a battery connector configured to electrically connect with a battery. The power source assembly also includes a snap-fit member configured to be connected with the main body to secure the battery to the main body. The power source assembly further includes a power output terminal provided on the main body. The power source assembly is configured to detachably mount to the gimbal.

### CROSS-REFERENCE TO RELATED APPLICATION

This application is a continuation application of International Application No. PCT/CN2016/112558, filed on Dec. 28, 2016, the entire contents of which are incorporated herein by reference.

### TECHNICAL FIELD

The present disclosure relates to the technology field of gimbals and, more particularly, to a power source assembly for a gimbal, a battery assembly, and a gimbal.

### BACKGROUND

Batteries have been widely used as power sources for various devices in multiple technical fields. For example, batteries have been used as power sources in handheld gimbals, handheld cameras, unmanned aerial vehicles, and robots, etc. Batteries provide electric power for continuous operations of these devices, such that these devices may be wirelessly controlled in some applications.

However, continuous operation time of these devices may be limited by the limited energy storage capacity of the batteries. When the batteries cannot be recharged in time, the batteries may have to be replaced to enable these devices to continue operations. In current technologies, a battery accommodation or receiving space may be provided on a housing of a device. A suitable structure, such as a cover, may be provided to secure the battery onto the device. This configuration, however, increases the overall dimension or volume of the device.

In addition, in the current technologies, the process for replacing the battery are complex.

### SUMMARY

In accordance with an aspect of the present disclosure, there is provided a power source assembly for a gimbal. The power source assembly includes a main body comprising a battery connector configured to electrically connect with a battery. The power source assembly also includes a snap-fit member configured to connect with the main body to secure the battery to the main body. The power source assembly further includes a power output terminal provided on the main body. The power source assembly is configured to detachably mount to the gimbal.

In accordance with another aspect of the present disclosure, there is also provided a battery assembly. The battery assembly includes a power source assembly configured to be detachably mounted to a gimbal to provide an electric power to the gimbal. The battery assembly also includes a battery configured to mount to the power source assembly. The power source assembly includes a main body comprising a battery connector configured to electrically connect with the battery. The power source assembly also includes a snap-fit member configured to connect with the main body to secure the battery to the main body. The power source assembly also includes a power output terminal provided on the main body. The power source assembly further includes a connecting assembly configured to detachably mount the power source assembly to the gimbal.

In accordance with another aspect of the present disclosure, there is also provided a gimbal. The gimbal includes a gimbal axes assembly. The gimbal also includes a motor assembly configured to drive the gimbal axes assembly to rotate. The gimbal also includes a power source assembly configured to provide an electric power to the motor assembly. The gimbal also includes a battery configured to mount to the power source assembly. The power source assembly is disposed on the motor assembly and the battery is also mounted to the motor assembly when the battery is mounted to the power source assembly. The power source assembly includes a main body comprising a battery connector configured to electrically connect with the battery. The power source assembly also includes a snap-fit member configured to connect with the main body to secure the battery to the main body. The power source assembly also includes a power output terminal provided on the main body. The power source assembly is configured to detachably mount to the gimbal.

The technical solution of the present disclosure has at least the following advantages: the present disclosure provides a power source assembly having a simple structure for providing electric power to a gimbal. The power source assembly can realize simple and fast assembly of batteries, including quick installation and disassembling of batteries. As a result, the efficiency of replacing batteries is improved. When the gimbal is not used, the batteries can be detached from the power source assembly to reduce the overall size of the device.

A person having ordinary skills in the art can appreciate that the above general descriptions and the following detailed descriptions are only intended to be illustrative and explanatory of example implementations of the disclosed technical solutions, and are not intended to limit the scope of the present disclosure.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a perspective view of an overall structure of a power source assembly, according to an example embodiment.

FIG. 2 is an exploded view of a power source assembly, according to an example embodiment.

FIG. 3 is a top view of a power source assembly, according to an example embodiment.

FIG. 4 is a partial exploded view of a lock-catch assembly of a power source assembly, according to an example embodiment.

FIG. 5 is a front view of a power source assembly, according to an example embodiment.

FIG. 6 is a perspective view of an overall structure of a power source assembly, according to another example embodiment.

FIG. 7 is an exploded view of a power source assembly, according to another example embodiment.

FIG. 8 is a top view of a power source assembly, according to another example embodiment.

FIG. 9 is a schematic illustration of a structure of a battery assembly, according to an example embodiment.

FIG. 10 is a schematic illustration of a structure of a battery assembly, according to another example embodiment.

FIG. 11 is a schematic illustration of a structure of a gimbal viewed from a perspective, according to an example embodiment.

FIG. 12 is a schematic illustration of a structure of a gimbal viewed from another perspective, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless.

When a first component is referred to as “disposed,” “located,” or “provided” on a second component, the first component may be directly disposed, located, or provided on the second component or may be indirectly disposed, located, or provided on the second component via an intermediate component. The term “on” does not necessarily mean that the first component is located higher than the second component. In some situations, the first component may be located higher than the second component. In some situations, the first component may be disposed, located, or provided on the second component, and located lower than the second component. In addition, when the first item is disposed, located, or provided “on” the second component, the term “on” does not necessarily imply that the first component is fixed to the second component. The connection between the first component and the second component may be any suitable form, such as secured connection (fixed connection) or movable contact.

When a first component is referred to as “disposed,” “located,” or “provided” in a second component, the first component may be partially or entirely disposed, located, or provided in, inside, or within the second component. When a first component is coupled, secured, fixed, or mounted “to” a second component, the first component may be is coupled, secured, fixed, or mounted to the second component from any suitable directions, such as from above the second component, from below the second component, from the left side of the second component, or from the right side of the second component.

The terms “perpendicular,” “horizontal,” “left,” “right,” “up,” “upward,” “upwardly,” “down,” “downward,” “downwardly,” “outward,” “outwardly,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure.

In addition, the singular forms “a,” “an,” and “the” are intended to include the plural forms as well, unless the context indicates otherwise. And, the terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

The following descriptions explain example embodiments of the present disclosure, with reference to the accompanying drawings. Unless otherwise noted as having an obvious conflict, the embodiments or features included in various embodiments may be combined.

The following embodiments do not limit the sequence of execution of the steps included in the disclosed methods. The sequence of the steps may be any suitable sequence, and certain steps may be repeated.

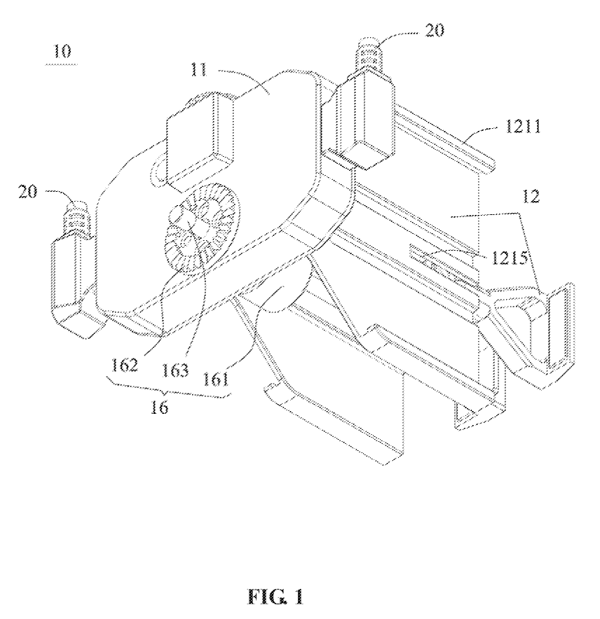

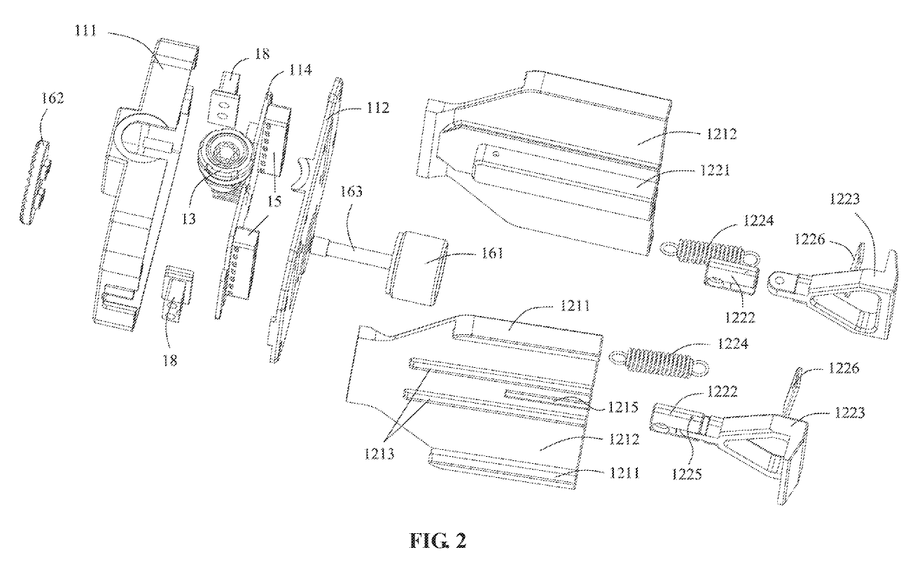

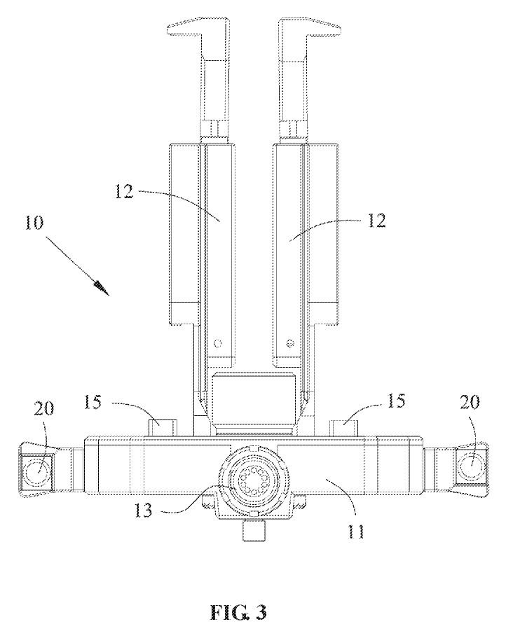

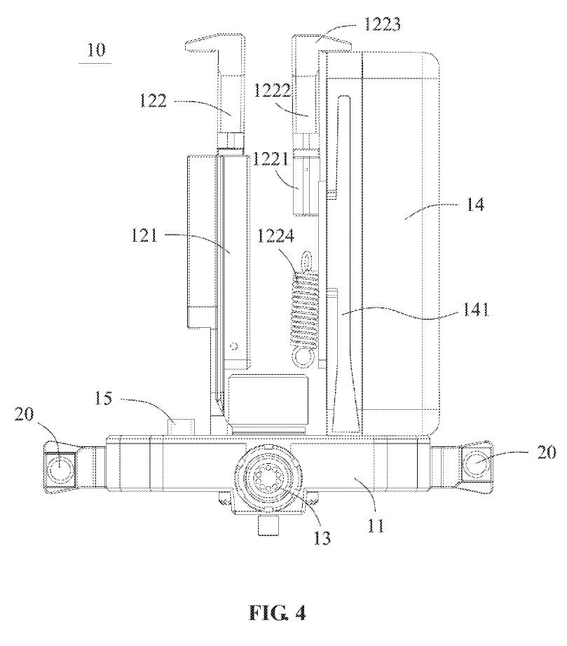

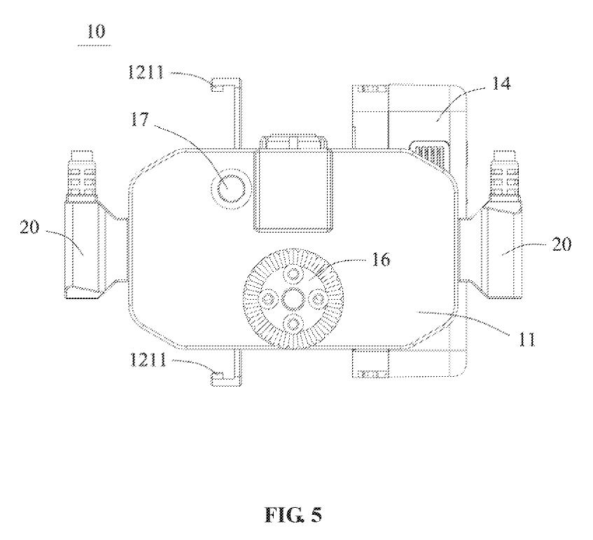

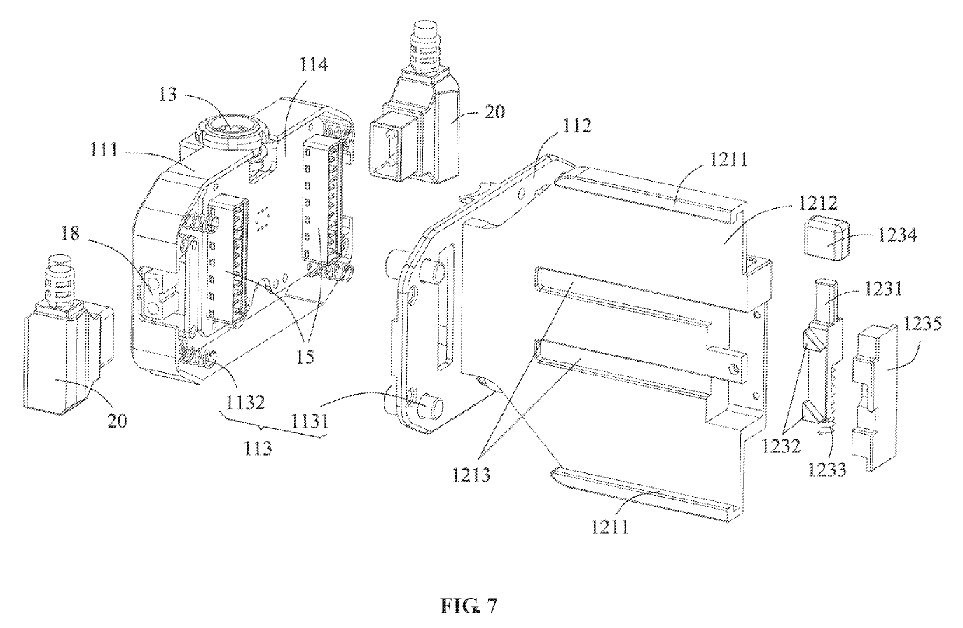

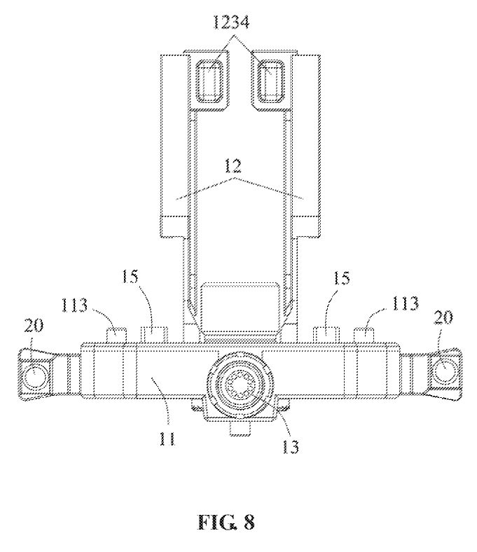

As shown in FIG. 1-FIG. 10, the present disclosure provides a power source assembly 10 for a gimbal. The power source assembly 10 may be used for installing or mounting a battery 14 configured to provide an electric power to the gimbal. The power source assembly 10 may include a connecting assembly 16 configured to detachably mount the power source assembly 10 to the gimbal. By detachably mounting the power source assembly 10 to the gimbal, the gimbal may be disassembled into multiple small-sized parts, which makes it convenient to transportation.

In some embodiments, the power source assembly 10 may include a main body 11, a snap-fit member 20 configured to be connected with the main body 11, and a power output terminal 13 provided on the main body 11. The main body 11 may include a mounting panel configured to mount the battery 14. The power output terminal 13 may be connected with the gimbal to provide the electric power to the gimbal. The snap-fit member 20 may be configured to fix or secure the battery 14 to the mounting panel of the main body 11. The main body 11 may include a battery connector 15 disposed on the mounting panel and configured to be electrically connected with the battery 14. In some embodiments, when the battery 14 is mounted to the power source assembly 10, the battery 14 may be first electrically connected to the battery connector 15, and then secured to the main body 11 through the snap-fit member 20. Through the disclosed structures, the battery 14 may be conveniently detached from the power source assembly 10, which makes the replacement of battery 14 simple and fast.

In some embodiments, the main body 11 may be configured for mounting at least two batteries 14. The main body 11 may include a plurality of battery connectors 15 and a plurality of snap-fit members 20 corresponding to a number of batteries 14. By providing at least two batteries 14 in the power source assembly 10, the continuous operation capability of the device to which the batteries are providing power may be enhanced. In addition, when one of the batteries 14 has a low electric charge, the battery may be replaced individually. The other one of the batteries 14 may continue to provide the electric power to the device, such that the operation of the device can continue without being interrupted.

In the embodiments shown in the drawings, two batteries 14 may be mounted to the power source assembly 10. The main body 11 may include two battery connectors 15 and two corresponding snap-fit members 20 connected with the battery connectors 15. Each battery 14 may be connected with a battery connector 15 and a snap-fit member 20. Through this configuration, each battery 14 may be securely connected to the power source assembly 10.

In some embodiments, the snap-fit member 20 may include a snap-fit support frame extending from a side of the main body 11 configured for mounting the battery 14. The snap-fit support frame may limit or secure the battery 14 to the main body 11. In some embodiments, the snap-fit member 20 is not limited to the snap-fit support frame shown in the drawings. Any suitable structure of the snap-fit member 20 that may securely mount the battery 14 to the main body 11 falls within the scope of the present disclosure.

In some embodiments, the snap-fit support frame may include a snap-fit panel 121. The snap-fit panel 121 may include a panel body 1212 and blocking members 1211 provided on two opposing sides of the panel body 1212. An end of the snap-fit panel 121 may be connected with the main body 11, another end of the snap-fit panel 121 may extend outwardly along the main body 11. The dimension of the snap-fit panel 121 may be determined based on a dimension of the battery 14. In some embodiments, the snap-fit panel 121 and the main body 11 may be disposed perpendicular to one another, which makes it convenient to connect the battery 14 to the battery connector 15 provided on the main body 11. As a result, a reliability of the connection between the battery 14 and the battery connector 15 can be enhanced.

In some embodiments, the blocking members 1211 may engage with the battery 14 to constrain or limit the movement of the battery 14 in directions (e.g., lateral directions) connecting the two opposing sides (i.e., the up and down sides) of the panel body 1212. For example, the two blocking members 1211 of the panel body 1212 together may clamp or snap the battery 14 between the two blocking members 1211, thereby supporting or carrying the battery 14.

In some embodiments, the blocking members 1211 may include a snap claw or a snap hook (the snap claw is used as an example in the following descriptions). The battery 14 may include a snap slot for fitting with the snap claw. The snap claw may fit into the snap slot. The snap claw and the panel body 1212 may limit the battery 14 to be located between the snap claw and the panel body 1212, thereby preliminarily positioning the battery 14. In other words, the movement of the battery 14 in directions connecting the two opposing sides of the panel body 1212 is limited or constrained, such that the battery 14 can only move in a direction relative to the main body 11.

In some embodiments, the battery 14 may not include a snap slot. The entire battery 14 may be limited to be located between the snap claw and the panel body, thereby initially positioning and supporting the battery 14. In some embodiments, the blocking members 1211 may include other suitable fitting mechanisms. For example, the blocking members 1211 may be configured to be moved and adjusted relative to one another, such that the snap-fit panel 121 may fit with batteries 14 of various sizes.

In some embodiments, the snap-fit support frame may include a lock-catch assembly 122. The lock-catch assembly 122 may be elastically disposed in the power source assembly 10, such that after the battery 14 is placed at the mounting position, the lock-catch assembly 122 may be adjusted to secure the battery 14. In some embodiments, the lock-catch assembly 122 may be disposed on the panel body 1212, which is explained in more detail below. In some embodiments, the lock-catch assembly 122 may be provided on the main body 11.

In some embodiments, as shown in FIG. 1-FIG. 5, the lock-catch assembly 122 may be provided on the snap-fit panel 121. For example, the lock-catch assembly 122 and the battery 14 may be disposed on two sides of the snap-fit panel 121 that face against one another. The lock-catch assembly 122 may include a position limiting member 1223. In some embodiments, the position limiting member 1223 may abut against the battery 14 to secure the battery 14 on the main body 11. In some embodiments, the position limiting member 1223 may include a pad 1226 (e.g., a cotton pad) for protecting the battery 14. The pad 1226 may be disposed on a side of the position limiting member 1223 opposing the main body 11. A distance between the position limiting member 1223 and the main body 11 may be adjusted. The distance between the position limiting member 1223 and the main body 11 when the lock-catch assembly 122 is in an initial state may be smaller than the distance between the position limiting member 1223 and the main body 11 when the lock-catch assembly 122 is in a locked (e.g., a tightly-locked) state. The position limiting member 1223 and the main body 11 together may limit the movement of the battery 14 to be in a mounting direction in which the battery 14 is mounted to the battery connector 15. The disclosed structures render the replacement of the battery 14 convenient. The battery 14 may be conveniently and quickly installed or disassembled through simple operations.

In some embodiments, the lock-catch assembly 122 may include a connecting arm 1221 and a sliding rod 1222 disposed in the connecting arm 1221. The position limiting member 1223 may be connected with an end of the sliding rod 1222 that is distant from the main body 11. The position limiting 1223 and the main body 11 together may secure the battery 14. In some embodiments, the connecting arm 1221 may include a structure that has a hollow central portion, such that the sliding rod 1222 may be disposed in the hollow central portion of the connecting arm 1221, thereby allowing the sliding rod 1222 to move relative to the connecting arm 1221. For example, the sliding rod 1222 may slide along an axial direction of the sliding rod 1222 in the connecting arm 1221. In the disclosed structures, the length of the lock-catch assembly 122 may be adjusted, thereby enabling adjustment of the distance between the position limiting member 1223 and the main body 11. In other words, the position limiting member 1223 and the main body 11 together may secure the battery 14.

In some embodiments, the lock-catch assembly 122 may include an extension spring 1224 disposed in the connecting arm 1221. An end of the extension spring 1224 may be connected with the connecting arm 1221, and another end of the extension spring 1224 may be connected with the sliding rod 1222. With the disclosed structure, the sliding rod 1222 may move within a specified range under the constraint of the resilient force provided by the extension spring 1224. For example, when the extension spring 1224 is in an initial state, the distance between the position limiting member 1223 and the main body 11 may be smaller than a dimension of the battery 14 in a longitudinal direction of the extension spring 1224. When mounting the battery 14, the sliding rod 1222 may be pulled outwardly, such that the distance between the position limiting member 1223 and the main body 11 is at least equal to the dimension of the batter 14 in the longitudinal direction of the extension spring 1224. The extension spring 1224 may be in a stretched or extended state, and may exert a resilient force on the sliding rod 1222. As this state, the position limiting member 1223 may abut against the battery 14, such that the battery 14 may be clamped between the position limiting member 1223 and the main body 11, thereby securing the battery 14. The present disclosure is not limited to using the extension spring 1224. Any suitable elastic member may replace the extension spring 1224.

In some embodiments, the snap-fit panel 121 may include an opening 1215. The opening 1215 may correspond to the mounting location of the connecting arm 1221. Because an end of the connecting arm 1221 is connected with the extension spring 1224, the connecting arm 1221 may rotate at the joint with the extension spring 1224 to thereby protrude from the opening 1215 until the connecting arm 1221 is disposed perpendicularly with the snap-fit panel 121. In the disclosed structure, the position limiting member 1223 connected with the connecting arm 1221 may be folded and received in a space between the panel body 1212 and the snap-fit panel 121.

In some embodiments, the lock-catch assembly 122 may include a pin 1225 disposed on an end of the sliding rod 1222 distant from the main body 11. The position limiting member 1223 may be connected with the sliding rod 1222 through the pin 1225, and may rotate around the pin 1225 using the pin 1225 as a rotating axis. In other words, the position limiting member 1223 may rotate relative to the sliding rod 1222. In some embodiments, the position limiting member 1223 may have a “7” shape, which makes it convenient to hook an end of the battery 14. When the position limiting member 1223 is not used to clamp the battery 14, the position limiting member 1223 may be rotated such that a snap-fit hook structure of the position limiting member 1223 faces other directions, thereby avoid damage to the position limiting member 1223.

In some embodiments, to mount the battery 14 to the power source assembly 10, the sliding rod 1222 may be pulled out from the connecting arm 1221, such that the position limiting member 1223 makes way for the battery 14. A space may be created for the battery 14 to be mounted to the snap-fit panel 121. At this state, the extension spring 1224 may be in an extended state when being pulled by an external force. Then, the battery 14 may be clamped between two blocking members 1211, such that the battery 14 can only move in a mounting direction of the main body 11. The panel body 1212 and the two blocking members 1211 together carry or support the battery 14. Next, the battery 14 may be pushed toward the main body 11, until the battery 14 is connected with the battery connector 15. Then the sliding rod 1222 is released. Under the resilient force of the extension spring 1224, the sliding rod 1222 causes the position limiting member 1223 to abut against an end of the battery 14 that is distant from the main body 11, thereby limiting the movement of the battery 14 to be in the mounting direction of the main body 11. Through these processes, the battery 14 may be securely mounted to the power source assembly 10. To detach the battery 14, the sliding rod 1222 may be pulled out from the connecting arm 1221, to provide a space for detaching the battery 14. The battery 14 may then be detached. The disclosed method for securing the battery 14 can realize fast and convenient disassembling and mounting of the battery 14. In addition, the power source assembly 10 has a simple structure, and the operation of the power source assembly 10 is also simple.

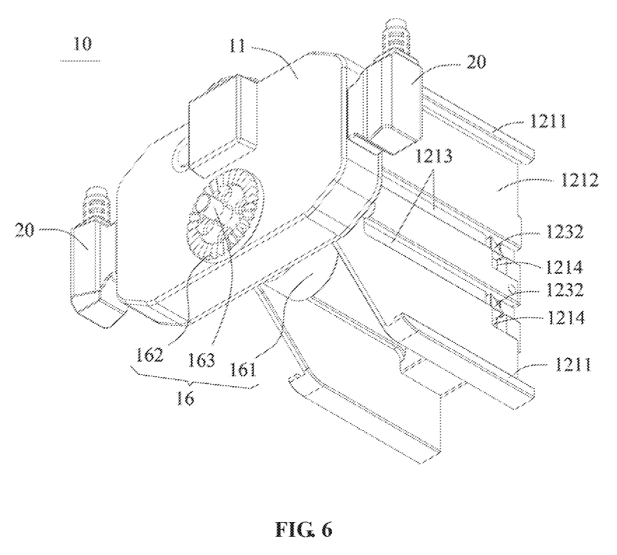

In some embodiments, as shown in FIG. 6-FIG. 10, the lock-catch assembly 122 may be disposed on the snap-fit panel 121. The lock-catch assembly 122 may be disposed at an end of the snap-fit panel 121 distant from the main body 11. The lock-catch assembly 122 may include an abutting member 1232 configured to clamp the battery 14. The snap-fit support frame may include a sliding groove 1213. The abutting member 1232 may be adjustably movable between entering the sliding groove 1213 and exiting the sliding groove 1213. In some embodiments, the battery 14 may include a protruding edge that is configured to fit with the sliding groove 1213. The sliding groove 1213 and the protruding edge together define the only mounting position at the snap-fit support frame for the battery 14, thereby avoiding upside-down installation of the battery 14. Then, after the battery 14 is mounted to the power source assembly 10, an end of the battery 14 may be connected to the connecting assembly 16 of the main body 11. The abutting member 1232 may be adjusted to slide into the sliding groove 1213 to thereby abut against the other end of the battery 14, thereby securing the battery 14.

In some embodiments, the lock-catch assembly 122 may include a positioning rod 1231. The abutting member 1232 may be disposed on the positioning rod 1231. The positioning rod 1231 may be mounted on the snap-fit panel 121 and may be adjusted to move in directions connecting two opposing sides of the snap-fit panel 121, thereby causing the abutting member 1232 to enter into the sliding groove 1213 or exit from the sliding groove 1213. In some embodiments, before the battery 14 is mounted to the snap-fit support frame or after the battery 14 is mounted to the snap-fit support frame, the abutting member 1232 may be disposed in the sliding groove 1213. At this configuration, the distance between the abutting member 1232 and the main body 11 may be equal to a lateral dimension of the battery 14. When the battery 14 is mounted to the snap-fit support frame, the positioning rod 1231 may be adjusted to cause the abutting member 1232 to move out of the sliding groove 1213, such that the battery 14 may be conveniently mounted to the snap-fit support frame. After the battery 14 is mounted to the snap-fit support frame, the positioning rod 1231 may be adjusted again to cause the abutting member 1232 to abut against an end of the battery 14 that is distant from the main body 11, thereby securing the battery 14.

In some embodiments, the abutting member 1232 may be a wedge block. In a direction in which the snap-fit panel 121 extends away from the main body 11, the wedge block has a reduced size. Such a structure renders the abutting member 1232 to have a leading surface, which makes it convenient for the battery 14 to be mounted directly. In other words, when the battery 14 is mounted, a protruding edge may abut against the abutting member 1232, which causes the abutting member 1232 to exit the sliding groove 1213 under a pressing force (e.g., when the battery 14 is mounted, the abutting member 1232 is disposed outside of the sliding groove 1213).

In some embodiments, the lock-catch assembly 122 may include an elastic member 1233 connected between an end of the positioning rod 1231 and the panel body 1212. In some embodiments, the elastic member 1233 may be a spring. In some embodiments, the elastic member 1233 may be an elastic plastic material, an elastic strip, etc. Through the spring, the positioning rod 1231 may be elastically pressed and controlled, which makes it convenient to control the lock-catch assembly 122. In some embodiments, when the elastic member 1233 is in an initial state, the abutting member 1232 may be disposed in the sliding groove 1213. When the elastic member 1233 is in an extended state or in a compressed state, the abutting member 1232 may be controlled to exit the sliding groove 1213 to avoid interfering with the mounting of the battery 14 (e.g., when the battery 14 is to be mounted, the abutting member 1232 is disposed outside of the sliding groove 1213). In some embodiments, the lock-catch assembly 122 may include a pressing switch 1234 disposed on another end of the positioning rod 1231 configured to adjust the movement of the positioning rod 1231 in directions connecting the two opposing sides of the panel body 1212.

In some embodiments, the elastic member 1233 may be compressed to cause the abutting member 1232 to exit the sliding groove 1213 (e.g., the abutting member 1232 is disposed outside of the sliding groove 1213). Correspondingly, the panel body 1212 may include a receiving portion 1214 connected with the sliding groove 1213. The receiving portion 1214 may be configured to receive the abutting member 1232. When the abutting member 1232 exits from the sliding groove 1213, the abutting member 1232 may be received in the receiving portion 1214. In some embodiments, the abutting member 1232 may not protrude out of a side of the panel body 1212 facing against the battery 14, so as to avoid interfering with the mounting of the battery 14.

In some embodiments, the lock-catch assembly 122 may include a covering plate 1235 mounted to the panel body 1212. The mounting surface for the battery 14 may be a side surface of the covering plate 1235 opposing the battery 14. The covering plate 1235 may be mounted at an end of the panel body 1212 distant from the main body 11. The covering plate 1235 may be configured to constrain the positioning rod 1231 and the elastic member 1233 in a receiving space of the panel body 1212. In some embodiments, the covering plate 1235 may be fixedly mounted to the panel body 1212 through screws and/or rivets. In some embodiments, the covering plate 1235 may be detachably mounted for the convenience of mounting the positioning rod 1231 and the elastic member 1233.

In some embodiments, when the battery 14 is to be mounted to the power source assembly 10, the battery 14 may be clamped between the two blocking members 1211. The protruding edge of the battery 14 may be inserted into a corresponding sliding groove 1213, thereby limiting the movement of the battery 14 to be in the mounting direction of the main body 11. The battery 14 may then be pushed toward the main body 11. This may cause the protruding edge of the battery 14 to abut against the abutting member 1232. The pressing force may cause the abutting member 1232 to move toward the receiving portion 1214 until the abutting member 1232 is substantially entirely disposed in the receiving portion 1214. In some embodiments, the pressing switch 1234 may be pressed to drive the positioning rod 1231 to move, which in turn may cause the abutting member 1232 to move until the abutting member 1232 exits the sliding groove 1213. At this state, the positioning rod 1231 may move together with the abutting member 1232 and may cause the elastic member 1233 to be in a compressed state. Then the battery 14 may continue to be pushed, until the battery 14 is connected with the battery connector 15. At this state, an end of the battery 14 that is distant from the main body 11 may move over the abutting member 1232. Thus, the abutting member 1232 is no longer under a force exerted by the battery 14. Under the resilient force of the elastic member 1233, the positioning rod 1231 and the abutting member 1232 may be driven to move back, such that the abutting member 1232 may again slide into the sliding groove 1213 to abut against an end of the battery 14 that is distant from the main body 11, thereby securing the battery 14. When the battery 14 is to be disassembled, the pressing switch 1234 may be pressed to cause the abutting member 1232 to exit from the sliding groove 1213. At this state, the elastic member 1233 may be in a compressed state. The battery 14 may be moved in a direction moving away from the main body 11 until the battery 14 is separated from the blocking members 1211. At this state, when the force exerted on the pressing switch 1234 is released, the positioning rod 1231 may cause the abutting member 1232 to move under the resilient force of the elastic member 1233, until the abutting member 1233 slides into the sliding groove 1213.

The present disclosure is not limited to the above-described embodiments. Other lock-catch assembly 122 having other suitable structures also falls within the scope of the present disclosure. For example, in some embodiments, the lock-catch assembly 122 may be tightened by rotating the position limiting member 1223.

In some embodiments, the main body 11 may include a pre-loaded contact 113 disposed adjacent the battery connector 15. The pre-loaded contact 113 may be configured to detect a mounting quality or a degree of mounting (or connection, or coupling) between the battery 14 and the battery connector 15. In other words, the degree at which battery 14 abuts against the pre-loaded contact 13 may indicate whether the connection between the battery 14 and the battery connector 15 is complete. Through the disclosure structure, the reliability of the connection between the battery 14 and the battery connector 15 may be improved.

In some embodiments, the main body 11 may include a housing 111 and a cover 112 provided on the housing 111. The pre-loaded contact 113 may include a contacting head 1131 and a compression spring 1132 disposed between and connected with the contacting head 1131 and the housing 111. When the pre-loaded contact 113 is not under an external force, the contacting head 1131 protrudes out of the cover 112. When the battery 14 is mounted to the power source assembly 10, the battery 14 may abut against the pre-loaded contact 113 when the battery 14 is connected with the battery connector 15, which causes the contacting head 1131 to withdraw into the housing 111. At this state, the compression spring 1132 is in a compressed state. When the contacting head 1131 is completely withdrawn into the cover 112, it indicates that the connection between the battery 14 and the battery connector 15 is complete. In some embodiments, the pre-loaded contact 113 may include a pressure sensor. The connection between the battery 14 and the battery connector 15 may be indicated by the pressure value detected by the pressure sensor.

In some embodiments, the power source assembly 10 may include the connecting assembly 16 disposed on the main body 11. The connecting assembly 16 may be configured to detachably connect the power source assembly 10 to a gimbal, thereby making it convenient to use the power source assembly 10 and to carry the power source assembly 10 after it is detached. In some embodiments, the connecting assembly 16 may include a knob 161 disposed on a side surface of the main body 11, and a fixing pin 163 configured to engage with the knob 161. The fixing pin 163 may be disposed on the side of the main body 11 on which the snap-fit member 20 is provided, and may rotate when the knob 161 is adjusted. In some embodiments, by adjusting the fixing pin 163 through the knob 161, the fixing pin 163 may be engaged with the gimbal to couple with or separate from the gimbal. When the fixing pin 163 is coupled with or separated from the gimbal, the power source assembly 10 is correspondingly coupled with or separated from the gimbal.

In some embodiments, the connecting assembly 16 may include a connecting toothed disk 162. The connecting toothed disk 162 may be configured to engage with the gimbal. The gimbal may include a toothed disk correspondingly matching the connecting toothed disk 162. The connecting toothed disk 162 and the knob 161 may be located on two opposing sides of the main body 11, and may be configured to engage with the gimbal for preliminary positioning. In other words, the connecting toothed disk 162 may be disposed on a side of the main body 11 opposing the side where the snap-fit member 20 is provided. When the power source assembly 10 is to be mounted to the gimbal, the connecting toothed disk 162 may be engaged with the toothed disk of the gimbal for preliminary positioning. Then by operating the knob 161, the fixing pin 163 may be adjusted such that the power source assembly 10 is secured to the gimbal.

In some embodiments, the power output terminal 13 may be provided at a central portion of the main body 11. The power output terminal 13 may be configured to provide an electric power to the gimbal. In some embodiments, the power source assembly 10 may include at least one external output terminal 19. The external output terminal 19 may be provided on a side of the main body 11, and may be configured to connect with an external device 20. The external device 20 may include a follow focus, a camera, etc. The embodiment shown in the figures include two external output terminals 19 disposed on two sides of the main body 11 respectively. By including an external output terminal 19 for connecting with an external device 20, additional functions may be provided by the power source assembly 10, which expands the scope of utility of the power source assembly 10.

In some embodiments, the main body 11 may include a circuit board 114 disposed in the main body 11. The circuit board 114 may be electrically connected with the battery connector 15, the power output terminal 13, and the external output terminal 19. Through the circuit board 114, the battery connector 15 may be electrically connected with the power output terminal 13 and the external output terminal 19. The battery 14 may provide the electric power to the external device 20 through the circuit board 114. In some embodiments, the circuit board 114 may include a controller configured to distribute power provided by two batteries 14 to the power output terminal 13. In some embodiments, by distributing the power using the controller, when one of the two batteries 14 is being replaced, the power supply to the gimbal would not be interrupted. Thus, the gimbal may continue operations using power provided by the other one of the two batteries 14.

In some embodiments, the main body 11 may include a power switch 17. The power switch 17 may be electrically connected with the circuit board 114, and may be configured to control the power supply from the power source assembly 10 to the gimbal or the external device 20.

In some embodiments, the power source assembly 10 may be mounted with at least two batteries 14, thereby extending the continuous operation capability of the device. When one of the batteries 14 is being replaced, the power supply to the device is not interrupted. Through the snap-fit member 20, the battery 14 may be quickly installed or detached, thereby increasing the efficiency of replacing battery 14. The entire power source assembly 10 may be detachably mounted to the gimbal through the connecting assembly 16, making it convenient to use or detach and carry the power source assembly 10. In addition, the power source assembly 10 may be provided with a power output terminal 13 for providing power to the external device 20, thereby expanding the functions of the gimbal.

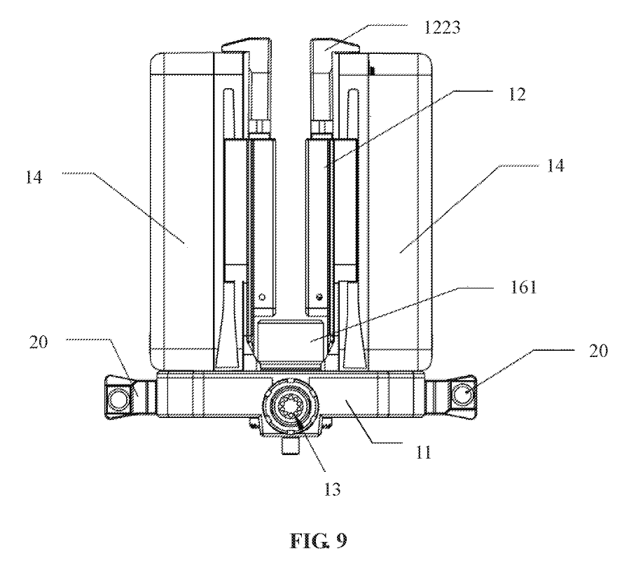

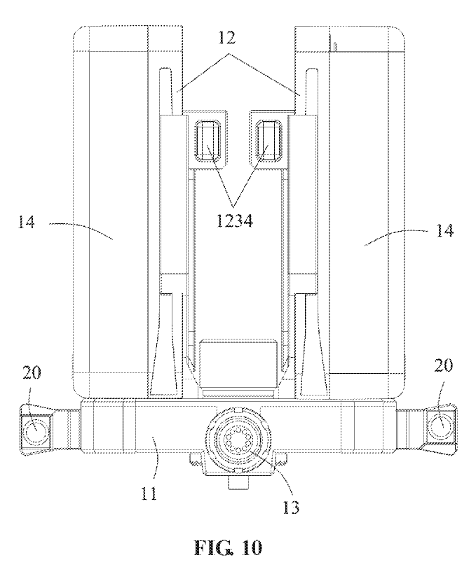

In some embodiments, as shown in FIG. 9 and FIG. 10, the present disclosure also provides a battery assembly. The battery assembly may include the power source assembly 10 described above and the battery 14 mounted to the power source assembly 10. The battery 14 may be quickly mounted to the power source assembly 10, or may be quickly detached from the power source assembly 10, which makes it convenient to replace the battery 14. In some embodiments, the power source assembly 10 may be mounted with two batteries 14. A controller provided on the circuit board 114 of the main body 11 may distribute the power provided by the two batteries 14. When one of the batteries 14 is being replaced, the controller may control the other battery 14 to continue providing power to the gimbal, such that the operation of the gimbal is not affected.

In some embodiments, to facilitate the mounting of the battery 14 to the power source assembly 10, at the top portion and bottom portion of the battery 14, the battery 14 may include a snap slot respectively to fit with the power source assembly 10, thereby limiting the movement of the battery 14 to be in the mounting direction in which the battery 14 is mounted to the battery connector 15. In some embodiments, the snap slots and the blocking members 1211 of the snap-fit panel may engage with one another to preliminarily position the battery 14 to place the battery 14 in predetermined mounting track.

In some embodiments, a side surface of the battery 14 that faces the snap-fit member 20 of the power source assembly 10 is provided with a protruding edge (not shown) configured to fit and connect with the snap-fit member 20. Through the coupling between the protruding edge and the snap-fit panel 121 and the lock-catch assembly 122, the battery 14 may be secured. The detailed method or structure for securing the battery 14 can refer to the above descriptions of the embodiment of the power source assembly 10.

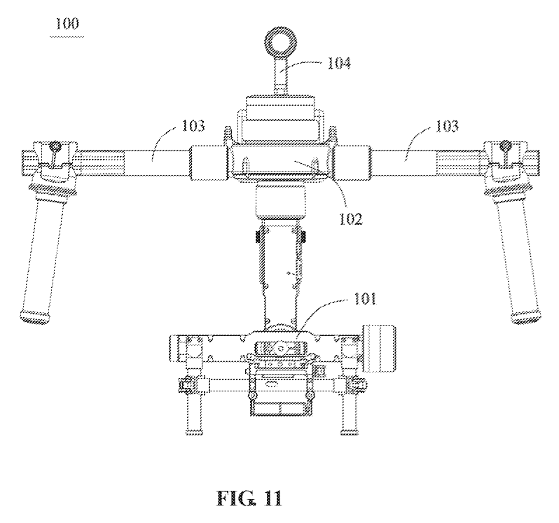

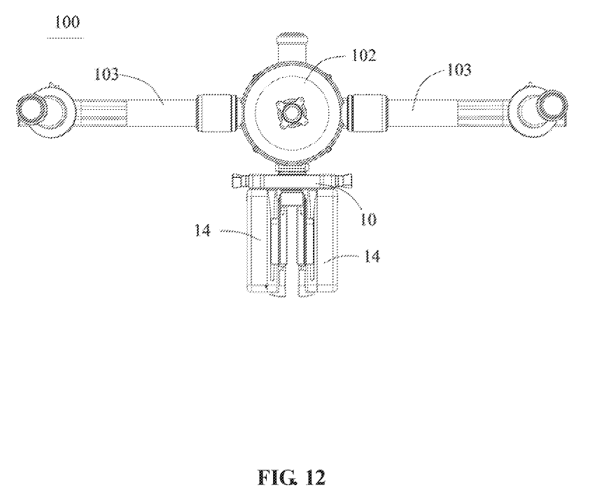

As shown in FIG. 11 and FIG. 12, the present disclosure also provides a gimbal 100. The gimbal 100 may include a gimbal axes assembly 101, and a motor assembly 102 configured to drive the gimbal axes assembly 101 to rotate. The gimbal 100 may also include the power source assembly 10 configured to provide the electric power to the motor assembly 102, and the battery 14 mounted in the power source assembly 10. The power source assembly 10 may be mounted to the motor assembly 102 such that the battery 14 may be mounted to the motor assembly 102. In some embodiments, the power source assembly 10 may be detachably mounted to the motor assembly 102, such that when the gimbal 100 is to be used, the power source assembly 10 may be conveniently mounted to the gimbal 100 and is easy to use; when the gimbal 100 is not used, the power source assembly 10 may be conveniently detached and carried. The structure of the power source assembly 10 and the structure of the battery 14 have been described above.

In some embodiments, as shown in FIG. 1-FIG. 12, the motor assembly 102 may include a motor. The power source assembly 10 may be installed onto an external housing. The external housing of the motor may include a toothed disk (not shown). In some embodiments, the power source assembly 10 may be mounted to the external housing of the motor through the connecting toothed disk 162 of the connecting assembly 16 engaging with the toothed disk of the external housing of the motor. The knob 161 may be operated to adjust the fixing pin 163 to secure the power source assembly 10 to the external housing of the motor. In some embodiments, the motor included in the motor assembly 102 may be a yaw-axis motor configured to adjust an angle of the gimbal, thereby adjusting an angle of an imaging device carried by the gimbal to capture images from different angles.

In some embodiments, the gimbal 100 may include a handheld horizontal rod 103 connected to a side of a motor of the motor assembly. The handheld horizontal rod 103 may include a left handle and a right handle connected to two sides of the motor assembly 102, respectively, for an operator to hold. The operator may hold the handheld horizontal rod 103 to conveniently hold and control the gimbal 100 when capturing images while moving around. In some embodiments, the handheld horizontal rod 103 may be disposed in a first longitudinal direction of the motor. The power source assembly 10 may be disposed in a second longitudinal direction of the motor. The first longitudinal direction and the second longitudinal direction may form an angle. In some embodiments, the angle is 90 degrees, which may make it convenient for an operator to hold the gimbal.

In some embodiments, the gimbal 100 may include an upper handle 104 disposed on the motor assembly 102, such that the operator may hold and support the gimbal 100 when capturing images in different angles. A handle axis of the upper handle 104 may be parallel with the second longitudinal direction. In some embodiments, an extending direction of the axis of the upper handle 104 may be parallel with the mounting direction in which the battery 14 is mounted to the battery connector 15. In some embodiments, the upper handle 104 may be detachably mounted to the gimbal axes assembly 101, such that the handheld horizontal rod 103 may be mounted or detached from the gimbal axes assembly 101 based on application needs.

The present disclosure provides a power source assembly having a simple structure. The power source assembly may be configured for mounting a battery, and may be used for simple, fast mounting of the battery. The battery may be quickly installed to the power source assembly or detached from the power source assembly. The battery replacing efficiency can be improved. In some embodiments, the power source assembly may be mounted with two batteries, which boost the continuous operation capability of the gimbal. In some embodiments, the power source assembly may be configured such that one of the two batteries can provide sufficient power to the gimbal for normal operations of the gimbal. When one of the batteries needs replacement, the power supply to the gimbal is not interrupted, such that the normal operations of the gimbal are not affected. The entire power source assembly may be detached from the gimbal, which makes it convenient to use and transport the power source assembly. The present disclosure also provides a design of the battery having a structure that fits with the power source assembly. The present disclosure further provides a design of the gimbal including the power source assembly and the battery.

It should be understood that in the present disclosure, relational terms such as first and second, etc., are only used to distinguish an entity or operation from another entity or operation, and do not necessarily imply that there is an actual relationship or order between the entities or operations. The terms “comprising,” “including,” or any other variations are intended to encompass non-exclusive inclusion, such that a process, a method, an apparatus, or a device having a plurality of listed items not only includes these items, but also includes other items that are not listed, or includes items inherent in the process, method, apparatus, or device. Without further limitations, an item modified by a term “comprising a . . . ” does not exclude inclusion of another same item in the process, method, apparatus, or device that includes the item.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A power source assembly for a gimbal, comprising:
a main body comprising a battery connector configured to electrically connect with a battery;
a snap-fit member configured to connect with the main body to secure the battery to the main body; and
a power output terminal provided on the main body, wherein the power source assembly is configured to detachably mount to the gimbal.

2. The power source assembly of claim 1, wherein the snap-fit member comprises a snap-fit support frame extending from a side of the main body that is configured for mounting the battery.

3. The power source assembly of claim 2, wherein the snap-fit support frame comprises a snap-fit panel configured for supporting the battery.

4. The power source assembly of claim 3,
wherein the snap-fit panel comprises a panel body and blocking members provided on two opposing sides of the panel body, and
wherein the blocking members are configured to limit movement of the battery in directions connecting the two opposing sides of the panel body.

5. The power source assembly of claim 2, wherein the snap-fit support frame comprises a lock-catch assembly elastically disposed in the power source assembly and configured to lock the battery to the snap-fit support frame.

6. The power source assembly of claim 5,
wherein the lock-catch assembly comprises a position limiting member configured to abut against the battery,
wherein a distance between the position limiting member and the main body is adjustable, and
wherein when the lock-catch assembly is in an initial state, a first distance between the position limiting member and the main body is smaller than a second distance between the position limiting member and the main body when the lock-catch assembly is in a locked state.

7. The power source assembly of claim 6,
wherein the lock-catch assembly comprises a connecting arm and a sliding rod disposed in the connecting arm,
wherein the position limiting member is configured to connect with an end of the sliding rod distant from the main body,
wherein the sliding rod is configured to move relative to the connecting arm to adjust the distance between the position limiting member and the main body, and
wherein the position limiting member is configured to engage with the main body to secure the battery.

8. The power source assembly of claim 5,
wherein the lock-catch assembly comprises an abutting member configured to abut against the battery,
wherein the snap-fit support frame comprises a sliding groove, and
wherein the abutting member is adjustably movable between entering the sliding groove and exiting the sliding groove.

9. The power source assembly of claim 8,
wherein the lock-catch assembly comprises a positioning rod,
wherein the abutting member is disposed on the positioning rod,
wherein before the battery is mounted to the snap-fit support frame or after the battery is mounted to the snap-fit support frame, the abutting member is disposed in the sliding groove, and
wherein when the battery is mounted to the snap-fit support frame, the abutting member is disposed outside of the sliding groove.

10. The power source assembly of claim 9,
wherein the abutting member comprises a wedge block having a reduced size in a direction in which the snap-fit panel extends away from the main body.

11. The power source assembly of claim 9,
wherein the lock-catch assembly comprises an elastic member configured to connect an end of the positioning rod and the panel body, and
wherein when the elastic member is in an initiate state, the abutting member is disposed in the sliding groove.

12. The power source assembly of claim 9,
wherein the panel body comprises a receiving portion connected with the sliding groove and configured to receive the abutting member.

13. The power source assembly of claim 9,
wherein the lock-catch assembly comprises a covering plate mounted to the panel body and configured to constrain the positioning rod and the elastic member in the receiving portion of the panel body.

14. A battery assembly, comprising:
a power source assembly configured to be detachably mounted to a gimbal to provide an electric power to the gimbal; and
a battery configured to mount to the power source assembly, wherein the power source assembly comprises:
a main body comprising a battery connector configured to electrically connect with the battery;
a snap-fit member configured to connect with the main body to secure the battery to the main body;
a power output terminal provided on the main body; and
a connecting assembly configured to detachably mount the power source assembly to the gimbal.

15. The battery assembly of claim 14,
wherein the main body comprises a pre-loaded contact disposed adjacent the battery connector, the pre-loaded contact configured to detect a degree of connection between the battery and the battery connector.

16. The battery assembly of claim 14,
wherein the connecting assembly comprises:
a knob disposed on a side surface of the main body on which the snap-fit member is provided; and
a fixing pin configured to couple with or separate from the gimbal when the knob is adjusted, and
wherein the power source assembly couples with or separates from the gimbal when the fixing pin correspondingly couples with or separates from the gimbal.

17. The battery assembly of claim 14,
wherein the connecting assembly comprises a connecting toothed disk provided on the main body, the connecting toothed disk and the knob are disposed on two opposing sides of the main body, and
wherein the connecting toothed disk is configured to engage with the gimbal to pre-position the power source assembly.

18. The battery assembly of claim 14, wherein the power output terminal is disposed at a central portion of the main body, and is configured for connecting the gimbal.

19. A gimbal, comprising:
a gimbal axes assembly;
a motor assembly configured to drive the gimbal axes assembly to rotate;
a power source assembly configured to provide an electric power to the motor assembly; and
a battery configured to mount to the power source assembly,
wherein the power source assembly is disposed on the motor assembly and the battery is also mounted to the motor assembly when the battery is mounted to the power source assembly, and
wherein the power source assembly comprises:
a main body comprising a battery connector configured to electrically connect with the battery;
a snap-fit member configured to connect with the main body to secure the battery to the main body; and
a power output terminal provided on the main body, and
wherein the power source assembly is configured to detachably mount to the gimbal.

20. The gimbal of claim 19, further comprising:
a handheld horizontal rod configured to connect to a side of a motor of the motor assembly,
wherein the handheld horizontal rod is disposed in a first longitudinal direction of the motor, the power source assembly is disposed in a second longitudinal direction of the motor, and the first longitudinal direction and the second longitudinal direction form an angle.

21. The gimbal of claim 20, further comprising:
an upper handle disposed on the motor assembly,
wherein a handle axis of the upper handle is parallel with the second longitudinal direction.
